(19) United States
(12) Patent Application Publication
(10) Pub. No.: US 2003/0114067 A1
(43) Pub. Date: Jun. 19, 2003

(54) Coform nonwoven web and method of making same

(76) Inventors: David Michael Matela, Alpharetta, GA (US); Darryl Franklin Clark, Hendersonville, NC (US); Matthew Boyd Lake, Cumming, GA (US); Bryan David Haynes, Cumming, GA (US)

Correspondence Address: KIMBERLY-CLARK WORLDWIDE, INC., 401 NORTH LAKE STREET, NEENAH, WI, 54956

(21) Appl. No.: 10/023,148

(22) Filed: Dec. 13, 2001

(51) Int. Cl. D04H 1/00; D04H 3/00; D04H 5/00; D04H 13/00; B32B 5/16

(52) U.S. Cl. 442/365; 442/361; 442/362; 442/363; 442/364; 442/341; 442/414

(57) ABSTRACT

A coform nonwoven web from multicomponent meltblown filaments and an absorbent, wherein the absorbent material is substantially uniformly dispersed in the z-direction is disclosed. A process of preparing the coform nonwoven web by perturbing the meltblown filaments as they are being produced is also disclosed. The coform material can be used in a variety of absorbent articles such as diapers as the primary liquid retention layer. In addition, the coform nonwoven web can be used in a variety of other articles such as wipes.

### FIELD OF THE INVENTION

The present invention relates to a coform nonwoven web prepared from multicomponent meltblown filaments and a second material, which is useful as a primary liquid retention layer in absorbent articles, a liquid distribution layer in absorbent articles, among other articles of manufacture. The present invention also relates to the process of producing the coform nonwoven web.

### BACKGROUND OF THE INVENTION

Coform nonwoven webs or coform materials are known in the art and have been used in a wide variety of applications. The term “coform material” means composite materials comprising a mixture or stabilized matrix of thermoplastic fibers and a second material. Examples of the second material includes, for example, absorbent fibrous organic materials such as woody and non-wood pulp such as cotton, rayon, recycled paper, pulp fluff; superabsorbent materials such as superabsorbent particles and fibers; inorganic absorbent materials and treated polymeric staple fibers, and other materials such as non absorbent staple fibers and non-absorbent particles and the like. Exemplary coform materials are disclosed in commonly assigned U.S. Pat. No. 5,284,703 to Everhart et al.; U.S. Pat. No. 5,350,624 to Georger et al.; U.S. Pat. No. 4,100,324 to Anderson et al. and U.S. Pat. No. 4,818,464 to Lau et al.

In the prior art coforming processes, the composition of the coformed material generally varies in the z-direction (the direction through the material thickness). Typically, at the top and bottom surfaces of the coform material there is a higher concentration of the thermoplastic filaments and a lower concentration of the second material, as compared to the middle region of the product. Conversely, in the middle region of the coform material, there is typically a higher concentration of the second material and a lower concentration of the thermoplastic filaments, as compared to the top and bottom surfaces. In addition, coform materials are generally prepared from monocomponent filaments and rely upon capture of the second material in the coform by the monocomponent filaments. As a result, conventional coform materials usually only loosely contain some of the second material and, therefore, cannot be locked into a specific density and may tend to dust or lint, which is the escape of the second material during use. Further, the conventional coform process inherently results in a somewhat horizontal layered structure and machine direction oriented meltblown filaments.

Bicomponent filaments offer a combination of desired properties. For instance, certain polypropylene resins yield filaments that are strong but not particularly soft. Certain polyethylene resins yield filaments that are soft but not particularly strong. By combining both resins together in the form of bicomponent nonwoven filaments, a hybrid combination of strength and softness can be achieved. In addition, bicomponent filaments can offer other advantageous properties, such as having the ability to melt one component of the filaments while another component of the filaments retains its shape and strength. This allows a nonwoven web prepared from the bicomponent filaments to more easily form bonds between the filaments of the nonwoven web.

Bicomponent filaments have been disclosed in combination with pulp fibers and/or superabsorbents in the production of absorbent articles. See WO 00/29658, WO 00/29655 and WO 00/29657, all assigned to the assignee of the present application. However, it is not disclosed in these patent publications that the coform nonwoven composite has a substantially uniform structure in the z-direction. In addition, it is not disclosed in these patent publication how to produce a coform material from substantially continuous multicomponent filaments, wherein the coform material has a substantially uniform structure in the z-direction.

There is a need or desire in the art for a nonwoven web having improved fluid absorption and fluid handling properties, improved stability, a substantially uniform structure and the ability to lock a specific density into the structure, in addition to durability and softness. There is also a need in the art for absorbent articles such as, wipes, mops, diapers, training pants and other personal care articles or absorbent articles having these properties.

### SUMMARY OF THE INVENTION

The present invention provides a coform nonwoven web having a uniform structure. The coform nonwoven web of the present invention comprises a plurality of substantially continuous multicomponent thermoplastic filaments; and a second material which may be particles, fibers, or a mixtures of particles and fibers. The second material is substantially uniformly dispersed within the multicomponent thermoplastic filaments in the z-direction of the coform nonwoven web.

The present invention provides an absorbent nonwoven web having a uniform structure. The absorbent nonwoven web of the present invention comprises a plurality of substantially continuous multicomponent thermoplastic filaments; and an absorbent material which may be absorbent particles, absorbent fibers or a mixture of absorbent fibers and absorbent particles, wherein the absorbent material is substantially uniformly dispersed within the multicomponent thermoplastic filaments in the z-direction of the absorbent nonwoven web.

The present invention also provides a method of preparing the coform nonwoven web. The method includes

a. providing a first die;

b. extruding liquefied resin components of the multicomponent thermoplastic filaments through a plurality of orifices in the first die in the direction of a first axis;

c. attenuating the liquefied resin component of the multicomponent thermoplastic filaments into a plurality of discrete filaments by subjecting the liquefied resin components to a first fluid stream directed in the direction of the first axis along both sides of the orifices, wherein the orifices are locate adjacent to the first fluid stream, the first fluid stream has a fluid pressure and the first fluid stream is perturbed by varying the fluid pressure of the first fluid stream on both sides of the orifices;

d. introducing the second material into the first fluid stream to form a mixture of multicomponent thermoplastic filaments and second material; and

e. depositing the mixture onto a forming surface to form an coform nonwoven web.

In another method of the present invention, a second die to produce the multicomponent thermoplastic filaments of the coform nonwoven web. When a second die is used, the method includes

a′. providing a second die;

b′. extruding liquefied resin components of the multicomponent thermoplastic filaments through a plurality of orifices in the second die in the direction of a second axis;

c′. attenuating the liquefied resin component of the multicomponent thermoplastic filaments into a plurality of discrete filaments by subjecting the liquefied resin components to a second fluid stream directed in the direction of the second axis along both sides of the orifices of the second die, wherein the orifices of the second die are located adjacent to the second fluid stream, the second fluid stream has a fluid pressure and the second fluid stream is perturbed by varying the fluid pressure of the second fluid stream on both sides of the orifices of the second die; wherein the first and second fluid streams converge to form a converged fluid stream and the second material is introduced into the converged fluid stream.

In addition, the coform nonwoven web of the present invention and the method of making the nonwoven web provides a nonwoven web having improved fluid absorption and fluid handling properties, improved stability, and the ability to lock in a specific density into the structure.

The present invention also provides for absorbent articles, comprising, as the primary liquid retention layer or a liquid distribution layer, the coform nonwoven web of the present invention. Examples of absorbent articles include personal care products such as diapers, training pants, swim diapers and the like. The absorbent nonwoven web can also be used to produce other products such as wipes, mops and the like.

### BRIEF DESCRIPTIONS OF THE DRAWINGS

FIG. 1 schematically shows a method to perturb the fluid flow of the quench air to the meltblown die heads.

FIG. 2 schematically show a process and apparatus used to produce a coform nonwoven web of the present invention.

FIG. 3 shows a schematic cross-section of the meltblown dies which can be used in the process of the present invention.

FIG. 4 schematically shows the laydown pattern of a coform nonwoven web without using a perturbed fluid flow.

FIG. 5 schematically shows the laydown pattern of a coform nonwoven web using a perturbed fluid flow.

FIG. 6 is a diagram showing horizontal wicking performance.

FIG. 7 is a diagram showing intake performance.

FIG. 8 is a diagram showing rewet performance.

### DEFINITIONS

As used herein, the term “comprising” is inclusive or open-ended and does not exclude additional unrecited elements, compositional components, or method steps.

As used herein, the term “fiber” includes both staple fibers, i.e., fibers which have a defined length between about 2 and about 20 mm, fibers longer than staple fiber but are not continuous, and continuous fibers, which are sometimes called “substantially continuous filaments” or simply “filaments”. The method in which the fiber is prepared will determine if the fiber is a staple fiber or a continuous filament.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, air-laying processes and bonded carded web processes. The basis weight of nonwoven webs is usually expressed in ounces of material per square yard (osy) or grams per square meter (gsm) and the fiber diameters useful are usually expressed in microns, or in the case of staple fibers, denier. It is noted that to convert from osy to gsm, multiply osy by 33.91.

As used herein, the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, which is hereby incorporated by reference in its entirety. Meltblown fibers are microfibers, which may be continuous or discontinuous, and are generally smaller than 10 microns in average diameter, and are generally tacky when deposited onto a collecting surface.

As used herein, the term “coform nonwoven web” or “coform material” means composite materials comprising a mixture or stabilized matrix of thermoplastic fibers and a second material. As an example, coform materials may be made by a process in which at least one meltblown die head is arranged near a chute through which the second material are added to the web while it is forming. The second material may be, for example, an absorbent material such as fibrous organic materials such as woody and non-wood pulp such as cotton, rayon, recycled paper, pulp fluff; superabsorbent materials such as superabsorbent particles and fibers; inorganic absorbent materials and treated polymeric staple fibers and the like; or a non-absorbent material, such as non-absorbent staple fibers or non-absorbent particles. Exemplary coform materials are disclosed in commonly assigned U.S. Pat. No. 5,284,703 to Everhart et al.; U.S. Pat. No. 5,350,624 to Georger et al.; U.S. Pat. No. 4,100,324 to Anderson et al.; and U.S. Pat. No. 4,818,464 to Lau et al.; the entire content of each is incorporated herein by reference.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making-up the fibers. The polymers are usually different from each other, although conjugate fibers may be prepared from the same polymer, if the polymer in each component is different from one another in some physical property, such as, for example, melting point or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random.

As used herein, through-air bonding or “TAB” means a process of bonding a nonwoven fiber web in which air, which is sufficiently hot to melt one of the polymers of which the fibers of the web are made, is forced through the web. The air velocity is between 100 and 500 feet per minute and the dwell time may be as long as 10 seconds. The melting and resolidification of the polymer provides the bonding. Through-air bonding has relatively restricted variability and since through-air bonding requires the melting of at least one component to accomplish bonding, it is generally restricted to webs with two components like multicomponent fibers or those webs which include an adhesive. In one type of through-air bonder, air having a temperature above the melting temperature of one component and below the melting temperature of another component is directed from a surrounding hood, through the web, and into a perforated roller supporting the web. Alternatively, the through-air bonder may be a flat arrangement wherein the air is directed vertically downward onto the web. The operating conditions of the two configurations are similar, the primary difference being the geometry of the web during bonding. The hot air melts the lower melting polymer component and thereby forms bonds between the filaments to integrate the web.

As used herein “thermal point bonded” means bonding one or more fabrics with a pattern of discrete bond points. As an example, thermal point bonding often involves passing a fabric or web of fibers to be bonded through a nip between a pair of heated bonding calender rolls. One of the bonding rolls is usually, though not always, patterned in some way so that the entire fabric is not bonded across its entire surface, and the second or anvil roll is usually a smooth surface. As a result, various patterns for calender rolls have been developed for functional as well as aesthetic reasons. One example of a pattern has points and is the Hansen Pennings or “H&P” pattern with about a 30% bond area with about 200 bonds/square inch as taught in U.S. Pat. 3,855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the C-Star pattern which has a bond area of about 16.9%. The C-Star pattern has a cross-directional bar or “corduroy” design interrupted by shooting stars. Other common patterns include a diamond pattern with repeating and slightly offset diamonds with about a 16% bond area and a wire weave pattern, having generally alternating perpendicular segments, with about a 19% bond area. Typically, the percent bonding area varies from around 10% to around 30% of the area of the fabric laminate web. Point bonding may be used to hold the layers of a laminate together and/or to impart integrity to individual layers by bonding filaments and/or fibers within the web.

As used herein, the term “perturbation” or “perturbed” means a change from the steady flow of fluid or the like. The change in fluid flow can be a momentary stoppage of the flow of fluid or a reduction or increase of the fluid pressure.

Furthermore, as used herein, the term “fluid” shall mean any liquid or gaseous medium; however, in general the preferred fluid is a gas and, more particularly, air.

### DETAILED DESCRIPTION

The present invention is directed to a coform nonwoven web comprising a mixture of substantially continuous multicomponent thermoplastic filaments and an second material which may be particles, fibers, or a mixture of particle and fibers. The nonwoven web of the present invention has a substantially uniform distribution of the second material and multicomponent filaments within the nonwoven web in the z-direction. That is, the concentration of the second material and multicomponent filaments is essentially the same at the bottom surface, middle and top surface of the nonwoven web.

The substantially continuous multicomponent thermoplastic filaments may have any of the multicomponent configurations described above. For ease of explanation, the multicomponent filaments will be referred to bicomponent filaments, wherein the first polymer will be referred to hereinafter as the A polymer component, and the second polymer will be referred to as the B polymer component. Desirably, the filaments have either of an A/B or A/B/A side-by-side configuration, or a sheath-core configuration, wherein polymer A surrounds polymer B. As referred herein, the A polymer has a lower melting point than the B component and the A polymer is preferably used in the sheath component of the multicomponent filaments, or is a component which makes-up more than 50% of the surface area of the filament in a side-by-side configuration. Generally, a sheath-core configuration, or a A/B/A side-by-side configuration, provide a larger percentage of the lower melting point polymer on the surface of the filaments to contact, wet, and secure, the second material, and the other substantially continuous filaments also contained in the web. The substantially continuous filaments of the present invention may be generated using a meltblown process.

The substantially continuous multicomponent filaments contain at least two thermoplastic polymers. Although described in the context of bicomponent filaments, it should be understood that the filaments need not be bicomponent filaments in the sense that they may have more than two components.

The A polymer component may contribute one or more desirable properties beyond its low melting point and wettability of the second material in A polymer component's liquid state. For example, polar functional groups may be added to the A polymer component to aid in the attachment of the second material thereto. Polymers may also be provided in the A polymer component which have high wettability for liquid water distribution within the web. Also, the B polymer component may contribute one or more additional desirable properties beyond its strength and durability. The A polymer component and/or the B polymer component of the bicomponent filaments may include more than two distinct polymers in each component of the bicomponent polymer, with each polymer contributing unique properties. That is, the A polymer component and/or the B polymer component of the bicomponent filaments may contain a blend of polymers. For example, the bicomponent filaments may include a distinct polymer blend having desirable properties, adjacent to another distinct polymer or polymer blend. Additives, such as pigments and hydrophilic modifiers, may be incorporated into one or more polymers, or applied to the filament surfaces of the multicomponent filaments.

Examples of the A polymer components which contribute a low melting point and good wetting of the second material within the web may include, without limitation: polyolefins, such as polyethylene, polypropylene, polybutylenes, or fluropolyolefins and the like. Other polymers may include, without limitation: high pressure (branched) low density polyethylenes, linear low density polyethylenes in which the alpha-olefin comonomer content is more than about 10% by weight, copolymers of ethylene with at least one vinyl monomer (for example, ethylene vinyl acetate), copolymers of ethylene with unsaturated aliphatic carboxylic acids (including ester derivatives thereof) and copolymers of any two alpha-olefins having 2-20 carbon atoms wherein the content of each of the two comononers exceeds 10% by weight of the copolymer (including, for instance, ethylene-propylene rubbers). Also included are thermoplastic polyurethanes, A-B and A-B-A′ block copolymers where A and A′ are thermoplastic end blocks and B is an elastomeric block. These polymers can be used alone or in combination with one another as a blend to form the A polymer component of the multicomponent filaments.

The A polymer can also be selected such that it imparts wettability to multicomponent filaments. Examples of polymers which contribute wettability to a thermoplastic nonwoven web include without limitation polyamides, polyvinyl acetates, saponified polyvinyl acetates, saponified ethylene vinyl acetates, and other hydrophilic materials. A polymer generally contributes to the wettability of bicomponent filaments if a droplet of water positioned on a nonwoven web made from bicomponent filaments containing first and second polymers has a contact angle which is a) less than 90 degrees measured using ASTM D724-89, and b) less than the contact angle of a similar nonwoven web made from similar filaments containing only the first polymer. When used as an outer layer such as in a sheath-core bicomponent filament web, the hydrophilic polymer imparts surface wettability to the entire web

Examples of the B polymer component suitable for use in the present invention may include, without limitation: polypropylene, polyesters such as polybutylene terephthalate, polyethylene terephthalate, or Nylon and the like. Other polymers may include, without limitation: polypropylene homopolymers, polypropylene copolymers containing up to about 10% ethylene or another C₄-C₂₀ alpha-olefin comonomer, high density polyethylenes, linear low density polyethylenes in which the alpha-olefin comonomer content is less than about 10% by weight, polyamides, polyesters, polycarbonates, polytetrafluoroethylenes, and other high tensile materials. These polymers can be used alone or in combination with one another as a blend to form the B polymer component of the multicomponent filaments.

The second material of a coform nonwoven web of the present invention may be an absorbent material, such as absorbent fibers or absorbent particles, or non-absorbent materials, such as non-absorbent fibers or non-absorbent particles. The selection of the second material will determine the properties of the resulting coform. For example, the absorbency of the coform nonwoven web can be improved by using an absorbent material as the second material. The coform nonwoven web contains from about 5% to about 99% by weight of the absorbent material and about 1% to about 95% by weight of the multicomponent filaments. Generally, the amount of the second material can be selected by those skilled in the art depending on the final utility of the coform nonwoven web. The second material may make up from about 50 to about 98% by weight of the coform nonwoven web or desirably about 70 to about 95% by weight of coform web. Correspondingly, the multicomponent filaments make up about 2 to about 50% by weight of the coform nonwoven web or desirably about 5 to about 30% by weight of the coform nonwoven web.

The absorbent materials useful in the present invention include absorbent fibers, absorbent particles and mixtures of absorbent fibers and absorbent particles. Examples of the absorbent material include, but are not limited to, fibrous organic materials such as woody or non-woody pulp such as cotton, rayon, recycled paper, pulp fluff and also superabsorbent particles, inorganic absorbent materials, treated polymeric staple fibers and so forth. Desirably, although not required, the absorbent material is pulp, and/or superabsorbent fibers and/or particles.

The pulp fibers may be any high-average fiber length pulp, low-average fiber length pulp, or mixtures of the same. Preferred pulp fibers include cellulose fibers. The term “high average fiber length pulp” refers to pulp that contains a relatively small amount of short fibers and non-fiber particles. High fiber length pulps typically have an average fiber length greater than about 1.5 mm, preferably about 1.5-6 mm. Sources generally include non-secondary (virgin) fibers as well as secondary fiber pulp which has been screened. The term “low average fiber length pulp” refers to pulp that contains a significant amount of short fibers and non-fiber particles. Low average fiber length pulps typically have an average fiber length less than about 1.5 mm.

Examples of high average fiber length wood pulps include those available from the U.S. Alliance Coosa Pines Corporation under the trade designations Longlac 19, Coosa River 56, and Coosa River 57. The low average fiber length pulps may include certain virgin hardwood pulp and secondary (i.e., recycled) fiber pulp from sources including newsprint, reclaimed paperboard, and office waste. Mixtures of high average fiber length and low average fiber length pulps may contain a predominance of low average fiber length pulps. For example, mixtures may contain more than about 50% by weight low-average fiber length pulp and less than about 50% by weight high-average fiber length pulp. One exemplary mixture contains about 75% by weight low-average fiber length pulp and about 25% by weight high-average fiber length pulp.

The pulp fibers may be unrefined or may be beaten to various degrees of refinement. Crosslinking agents and/or hydrating agents may also be added to the pulp mixture. Debonding agents may be added to reduce the degree of hydrogen bonding if a very open or loose nonwoven pulp fiber web is desired. One exemplary debonding agent is available from the Quaker Oats Chemical Company, Conshohocken, Pa., under the trade designation Quaker 2008. The addition of certain debonding agents in the amount of, for example, 1-4% by weight of the pulp fibers, may reduce the measured static and dynamic coefficients of friction and improve the abrasion resistance of the thermoplastic continuous polymer filaments. The debonding agents act as lubricants or friction reducers. Debonded pulp fibers are commercially available from Weyerhaeuser Corp. under the designation NB 405.

In another highly advantageous embodiment, a quantity of a superabsorbent material is combined with the substantially continuous multicomponent thermoplastic polymer filaments, to improve the absorbency of the absorbent nonwoven web composite, with or without pulp fibers. The term “superabsorbent” or “superabsorbent material” refers to a water-swellable, water-insoluble organic or inorganic material capable, under the most favorable conditions, of absorbing at least about 10 times its weight and, more desirably, at least about 30 times its weight in an aqueous solution containing 0.9 weight percent sodium chloride, at room temperature and pressure.

The superabsorbent materials can be natural, synthetic and modified natural polymers and materials. In addition, the superabsorbent materials can be inorganic materials, such as silica gels, or organic compounds such as cross-linked polymers. The term “cross-linked” refers to any means for effectively rendering normally water-soluble materials substantially water insoluble but swellable. Such means can include, for example, physical entanglement, crystalline domains, covalent bonds, ionic complexes and associations, hydrophilic associations, such as hydrogen bonding, and hydrophobic associations or Van der Waals forces.

Examples of synthetic superabsorbent material polymers include the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), poly(vinyl alcohol), and mixtures and copolymers thereof. Further superabsorbent materials include natural and modified natural polymers, such as hydrolyzed acrylonitrile-grafted starch, acrylic acid grafted starch, methyl cellulose, chitosan, carboxymethyl cellulose, hydroxypropyl cellulose, and the natural gums, such as alginates, xanthan gum, locust bean gum and the like. Mixtures of natural and wholly or partially synthetic superabsorbent polymers can also be useful in the present invention. Other suitable absorbent gelling materials are disclosed by Assarsson et al. in U.S. Pat. No. 3,901,236 issued Aug. 26, 1975. Processes for preparing synthetic absorbent gelling polymers are disclosed in U.S. Pat. No. 4,076,633 issued Feb. 28, 1978 to Masuda et al. and U.S. Pat. No. 4,286,082 issued Aug. 25, 1981 to Tsubakimoto et al, each hereby incorporated by reference.

Superabsorbent materials may be xerogels which form hydrogels when wetted. The term “hydrogel,” however, has commonly been used to also refer to both the wetted and unwetted forms of the superabsorbent polymer material. The superabsorbent materials can be in many forms such as flakes, powders, particulates, fibers, continuous fibers, networks, solution spun filaments and webs. The particles can be of any desired shape, for example, spiral or semi-spiral, cubic, rod-like, polyhedral, etc. Needles, flakes, fibers, and combinations may also be used.

Superabsorbents are generally available in particle sizes ranging from about 20 to about 1000 microns. Examples of commercially available particulate superabsorbents include SANWET® IM 3900 and SANWET® IM-5000P, available from Hoescht Celanese located in Portsmouth, Va., SANWET® 2035LD available from Dow Chemical Co. located in Midland, Mich., and FAVOR® 880, available from Stockhausen, located in Greensborough, N.C. An example of a fibrous superabsorbent is OASIS® 101, available from Technical Absorbents, located in Grimsby, United Kingdom.

Desirably, the coform nonwoven web contains an absorbent material and the coform nonwoven web contains from about 5% to about 99% by weight of the absorbent material and about 1% to about 95% by weight of the multicomponent filaments. Generally, the amount of the absorbent material can be selected by those skilled in the art depending on the final utility of the coform nonwoven web. Generally, the more absorbent material present, the greater the absorbency of the resulting coform product. The absorbent material may make up from about 50 to about 98% by weight of the absorbent nonwoven web or desirably about 70 to about 95% by weight of the absorbent nonwoven web. Correspondingly, the multicomponent filaments make up about 2 to about 50% by weight of the absorbent nonwoven web or desirably about 5 to about 30% by weight of the coform nonwoven web.

When used, the superabsorbent material may be present within the absorbent nonwoven web in an amount from about 5 to about 99% by weight based on total weight of the coform nonwoven web. Preferably, the superabsorbent constitutes about 10-60% by weight of the coform nonwoven web composite, more preferably about 20-50% by weight. When the superabsorbent material is present, other absorbent fibers or particles may or may not be present. It is preferred, however, that the total weight of the absorbent material in the absorbent nonwoven web is between about 5 and about 99% by weight of the nonwoven web.

When the absorbent material contains a mixture of a superabsorbent material and a non-superabsorbent material, such as pulp, the superabsorbent desirably is present in an amount less than about 50% by weight of the absorbent material present in the absorbent nonwoven web, since superabsorbent materials are generally slow to absorb fluids. More preferably, the superabsorbent material is present in an amount of about 5 to about 25% by weight of the absorbent material present in the absorbent nonwoven web. In each case, the balance of the absorbent material is a non-superabsorbent material such as pulp.

The nonabsorbent material, which can be incorporated into the multicomponent filaments, includes nonabsorbent fibers and nonabsorbent particles. Examples of the fibers include, for example, staple fibers of untreated thermoplastic polymers, such as polyolefins and the like. Examples of nonabsorbent particles include activated charcoal, sodium bicarbonate and the like. The nonabsorbent material can be used alone or in combination with the absorbent material. It should be noted, however, that the total amount of the second material, whether absorbent or nonabsorbent should be between 5 and 99% by weight of the total weight of the coform nonwoven web.

The coform nonwoven web of the present invention is prepared by a method including:

a. providing a first die;

b. extruding liquefied resin components of the multicomponent thermoplastic filaments through a plurality of orifices in the first die in the direction of a first axis;

c. attenuating the liquefied resin component of the multicomponent thermoplastic filaments into a plurality of discrete filaments by subjecting the liquefied resin components to a first fluid stream directed in the direction of the first axis along both sides of the orifices, wherein the orifices are locate adjacent to the first fluid stream, the first fluid stream has a fluid pressure and the first fluid stream is perturbed by varying the fluid pressure of the first fluid stream on both sides of the orifices;

d. introducing the second material into the first fluid stream to form a mixture of multicomponent thermoplastic filaments and second material; and

e. depositing the mixture onto a forming surface to form an coform nonwoven web.

In forming the nonwoven web of the present invention, it is preferred, but not required that a second meltblown die is used to generate meltblown multicomponent filaments. When a second meltblown dies is used, the method of the present invention additionally includes

a′. providing a second die;

b′. extruding liquefied resin components of the multicomponent thermoplastic filaments through a plurality of orifices in the second die in the direction of a second axis;

c′. attenuating the liquefied resin component of the multicomponent thermoplastic filaments into a plurality of discrete filaments by subjecting the liquefied resin components to a second fluid stream directed in the direction of the second axis along both sides of the orifices of the second die, wherein the orifices of the second die are located adjacent to the second fluid stream, the second fluid stream has a fluid pressure and the second fluid stream is perturbed by varying the fluid pressure of the second fluid stream on both sides of the orifices of the second die; wherein the first and second fluid streams converge to form a converged fluid stream and the second material is introduced into the converged fluid stream.

The method of the present invention involves perturbing the fluid used to draw and attenuate the filaments from the die. Preferably, the fluid stream is alternately perturbed on opposite sides of an axis parallel to the direction of travel of the filament of as the filaments are extruded through the orifices of the die. Thus, the fluid stream carrying the forming filament is perturbed, resulting in perturbation of the filaments during formation.

In general, the fluid stream may be perturbed in a variety of ways; however, regardless of the method used to perturb the fluid stream, the perturbations have two basic characteristics, frequency and amplitude. The perturbation frequency may be defined as the number of pulses provided per unit time to either side. As is common the frequency will be described in Hertz (number of cycles per second) throughout the specification. The amplitude may also be described by the percentage increase or difference in fluid pressure (ΔP/P)×100 in the perturbed stream as compared to the steady state. Additionally, the perturbation amplitude may be described as the percentage increase or difference in the fluid stream flow rate during perturbation as compared to the steady state. Thus, the primary variables which may be controlled by the new fiber forming techniques are perturbation frequency and perturbation amplitude. The techniques described below easily control these variables. A final variable which may be changed is the phase of the perturbation. For the most part, a 180° phase differential in perturbation is described below (that is, a portion of the fluid stream flow on one side of an axis parallel to the direction of flow is perturbed and then the other side is alternately perturbed); however, the phase differential could be adjusted or varied between 0° to 180° to achieve any desired result. This variation allows for still more control over the fibers made thereby and the resulting web or material.

The perturbation of the fluid stream and filaments during formation has several positive effects on the fiber formed thereby. First, the particular characteristics of the fiber such as strength and crimp may be adjusted by variation of the perturbation. Thus, in nonwoven web materials, increased bulk and tensile strength may be obtained by selecting the proper perturbation frequency and amplitude. Increased crimp in the fiber contributes to increased bulk in the non-woven web, since crimped fibers tend to take up more space. Additionally, preliminary investigation of the characteristics of meltblown filaments made in accordance with the present invention, as compared to those made with prior art techniques, appears to indicate that fibers made in accordance with the present invention exhibit different crystalline and heat transfer characteristics. It is believed that such differences are due to heat transfer effects (including quenching) which result from the movement of fibers in a turbulent fluid flow. It is further believed that such differences contribute to the enhanced characteristics of fibers and nonwoven materials made in accordance with the techniques of the present invention. Additionally, the perturbation of the airflow also results in improved deposition of the fibers on the forming substrate, which enhances the strength and other properties of the web formed thereby.

Furthermore, since the variables of frequency and amplitude of the perturbation are easily controlled, fibers of different characteristics may be made by changing the frequency and/or amplitude. Thus, it is possible to change the character of the nonwoven web being formed during processing (or “on the fly”). By this type of adjustment, a single machine may manufacture nonwoven web fabrics having different characteristics required by different product specification while eliminating or reducing the need for major hardware or process changes. Additionally, the present invention does not preclude the use of conventional process control techniques to adjust the fiber characteristics.

Examples of methods which can be used to perturb the fluid flow of the present invention included the methods described in U.S. Pat. No. 5,667,749 to Lau et al, which is hereby incorporated by reference in its entirety. In addition, high speed rotary valves described in U.S. Pat. No. 5,913,329, to Haynes et al. which is hereby incorporated by reference in its entirety, can also be used. The preferred method of perturbing the fluid flow is by the use of a high-speed rotary valve.

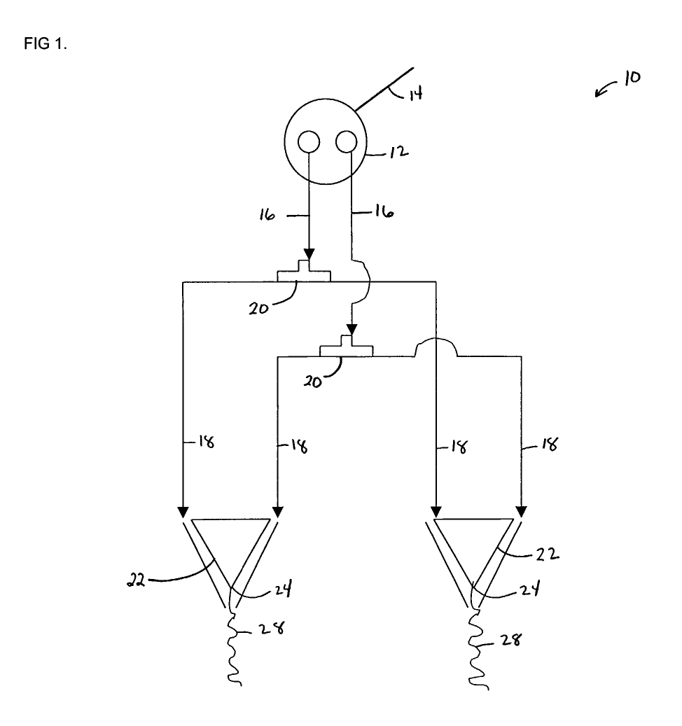

FIG. 1 shows a general schematic process 10 for perturbing the fluid flow to the meltblown dies 22. In the process of perturbing the fluid flow, the fluid is supplied to a high-speed rotary valve 12, via a supply line 14. Although not shown in the drawing, the high-speed rotary valve has a housing, a motor, a shaft, a rotor and a stator. The motor rotates a shaft and the rotor attached to the shaft inside the housing. Both the rotor and stator each have at least one passage which allows the fluid to pass through rotor and stator when the passages are line-up with one another as the rotor rotates. There are at least two types of high speed rotary valves, one which leaks-through and one which leaks-out. Leak through rotary valves are described in U.S. Pat. No. 5,913,329, to Haynes et al. and leak out rotary valves are described in U.S. Pat. No. 5,405,559 to Shambaugh, the contents of both are hereby incorporated by reference. Leak-through rotary valves are preferred in the present invention since the leak-through valve provides a continuous fluid flow and the leak out rotary valve provides a discontinuous fluid flow.

Returning to FIG. 1, the fluid enters the high-speed rotary valve through an inlet 14 and exits the rotary valve through outlets 16. Supply lines 18 transport the perturbed fluid to plenum chambers 20. From the plenum chambers 20, supply lines 18 transport the perturbed fluid to meltblown die heads 22. As the motor rotates the shaft and rotor of the high speed rotary valve, the flow of air to the meltblown die heads 22 is purturbed. Each meltblowing die is configured so that two streams of perturbed attenuating gas per die converge to form a single stream of gas which entrains and attenuates molten threads 28, as the threads 28 exit small holes or orifices 24 in the meltblowing die. The molten threads 28 are attenuated into multicomponent filaments or, depending upon the degree of attenuation, microfibers, of a small diameter which is usually less than the diameter of the orifices 24.

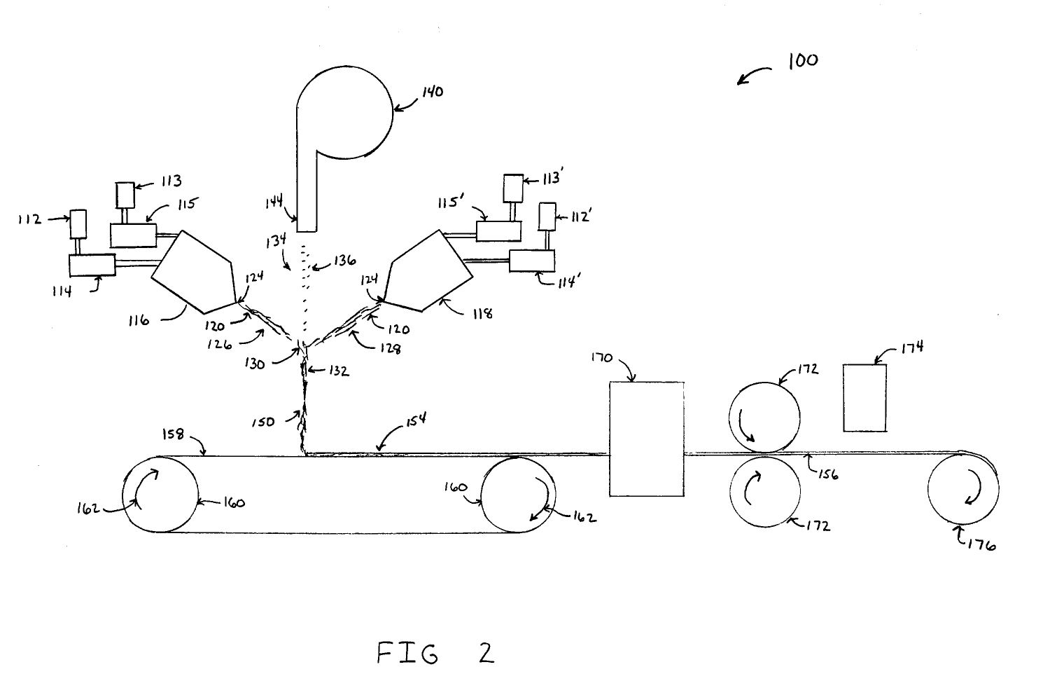

FIG. 2 schematically shows a process and apparatus for forming the coform nonwoven web of the present invention using two meltblown dies which is generally represented by reference numeral 100. As is noted above, it should again be noted that process of the present invention can be practiced using a single meltblown die. For ease of explanation, the process will be described in terms of using two meltblown dies. The process line 100 is arranged to produce bicomponent substantially continuous filaments, but it should be understood that the present invention comprehends nonwoven webs made with multicomponent filaments having more than two components. For example, the web of the present invention can be made with filaments having three, four or more components. In forming the absorbent nonwoven composite structure of the present invention, pellets or chips, etc. (not shown) of a thermoplastic polymer are introduced into a pellet hoppers 112, 112′, 113 and 113′ of an extruders 114, 114′, 115 and 115′.

The extruders 114, 114′, 115 and 115′ have an extrusion screw (not shown) which is driven by a conventional drive motor (also not shown). As the polymer advances through the extruders 114, 114′, 115 and 115′, due to rotation of the extrusion screw by the drive motor, it is progressively heated to a molten state. Heating the thermoplastic polymer to the molten state may be accomplished in a plurality of discrete steps with the temperature of the thermoplastic polymer being gradually elevated as it advances through discrete heating zones of the extruders 114, 114′, 115 and 115′ toward two meltblowing dies 116 and 118, respectively. The meltblowing dies 116 and 118 may be yet another heating zone where the temperature of the thermoplastic resin is maintained at an elevated level for extrusion.

Although not shown in FIG. 2, each meltblowing die is configured so that at least two streams of perturbed attenuating fluid per die converge to form a single stream of fluid which entrains and attenuates molten threads 120, as the threads 120 exit small holes or orifices 124 in each meltblowing die. The molten threads 120 are attenuated into filaments or, depending upon the degree of attenuation, microfibers, of a small diameter which is usually less than the diameter of the orifices 124. Thus, each meltblowing die 116 and 118 has a corresponding single stream of fluid 126 and 128, containing entrained and attenuated polymer filaments. The fluid streams 126 and 128 containing polymer filaments are aligned to converge at an impingement zone 130, and form a converged fluid stream 132, which contains the attenuated multicomponent filaments.

One or more types of the second material 136, which can include fibers and/or particulates are added to the two streams 126 and 128 of multicomponent filaments or microfibers 120 at the impingement zone 130. Introduction of second fibers or particulates 136 into the two streams 126 and 128 of multicomponent filaments 120 is designed to produce a distribution of the second material 136 within the combined streams 126 and 128 of multicomponent filaments. This may be accomplished by merging a secondary gas stream 134 containing the second fibers or particles 136 between the two streams 126 and 128 of the multicomponent filaments 120 so that all three gas streams converge in a controlled manner at the impingement zone 130.

Apparatus 140 generates the second gas stream 134 containing the absorbent material 136. The apparatus for accomplishing the merger of the fluid streams 126, 128 and 134 may include a conventional picker or particulate injection system. In a conventional picker roll arrangement, a plurality of teeth that are adapted to separate a mat or batt of an absorbent fibrous material into the individual absorbent fibers. The sheets or mats of the fibrous material are fed to the picker roll by a roller arrangement and the teeth of the picker roll separate the mat of fibrous material into separate fibers 136 which are conveyed toward the streams of thermoplastic multicomponent polymer filaments 126 and 128 through a nozzle 144, and optionally a chute 146. Generally a gas, for example, air, is supplied to the picker via a gas duct. The gas is supplied in sufficient quantity to serve as a medium for conveying the second fibers 136 through the nozzle 144. The gas may be supplied by any conventional arrangement such as, for example, an air blower (not shown). It is contemplated that additives and/or other materials may be add to or entrained in the gas stream to treat the second fibers.

The second material 136 generally maintains its velocity in both magnitude and direction. An example of a conventional picker can be found in, for example, U.S. Pat. No. 4,100,324 to Anderson, et al., hereby incorporated by reference in its entirety, which discusses the picker in more detail.

The width of the nozzle 144 should be aligned in a direction generally parallel to the width of the meltblowing dies 116 and 118. Desirably, the width of the nozzle 144 should be about the same as the width of the meltblowing dies 116 and 118. The width of the optional chute is likewise about the same as the width of the meltblowing dies 116 and 118. Usually, the width of the nozzle 144 should not exceed the width of the sheets or mats that are being fed to the picker roll. Generally speaking, it is desirable for the length of the nozzle 144 to be as short as equipment design will allow.

The apparatus 140 may also be a conventional particulate injection system to form a nonwoven web or coform composite structure 154 containing various particulates. In addition, a combination of both particulates and fibers could be added to the thermoplastic multicomponent polymer filaments prior to formation of the coform nonwoven web 154, if both a conventional particulate injection system and a conventional picker are used.

FIG. 2 further illustrates that the secondary fluid stream 134 carrying the second material 136 is directed between the fluid streams 126 and 128 of thermoplastic multicomponent polymer filaments so that the streams contact at the impingement zone 130. Apparatus 140 is shown to be located between the meltblown dies 116 and 118, however, it should be noted that the apparatus 140 could be located below the meltblown dies 116 and 118 such that the absorbent material could be injected into the converged stream 132, at or below the impingement zone 130 of fluid streams 126 and 128. The velocity of the secondary fluid stream 134 is usually adjusted so that it is less than the velocity of each stream 126 and 128 of thermoplastic multicomponent polymer filament when the streams contact at the impingement zone 130, which results in better homogenous mixing of the second material with the multicomponent filaments. However, it should be noted that the velocity of the fluid stream 134 can be greater than the velocity of streams 126 or 128, or the converged stream 132.

The perturbed nature of the streams 126 and 128 and the velocity difference these streams 126, 128 and the fluid stream 134 of the second material 136, results in the second material 136 being integrated into the streams of the multicomponent thermoplastic polymer filaments 126 and 128 in such manner that the second material 136 becomes homogeneously integrated into the multicomponent thermoplastic polymer filaments 120. Generally, for increased production rates the perturbed fluid streams which entrain and attenuate the multicomponent thermoplastic polymer fibers 120 should have a comparatively high initial average velocity, for example, from about 200 feet to over 1,000 feet per second. However, the velocity of those fluid streams 126,128 decreases rapidly as they expand and become separated from the meltblowing die. Thus, the velocity of those fluid streams126, 128 at the impingement zone may be controlled by adjusting the distance between the meltblowing die and the impingement zone 130. The fluid stream 134, which carries the second material 136, will have a low initial velocity when compared to the fluid streams 126 and 128 which carry the meltblown fibers. However, by adjusting the distance from the nozzle 144 to the impingement zone 130 (and the distances that the meltblown fiber gas streams 126 and 128 must travel), the velocity of the fluid stream 134 can be controlled to be greater than the meltblown fiber fluid streams 126 and 128 at the impingement zone.

Due to the fact that the multicomponent thermoplastic polymer fibers 120 are usually still semi-molten and tacky at the time of incorporation of the second material 136 into the multicomponent thermoplastic polymer filaments containing streams 126 and 128, the second material 136 is usually not only mechanically entangled within the matrix formed by the thermoplastic polymer fibers 120 but is also thermally bonded or joined to the multicomponent thermoplastic polymer fibers 120.

In order to convert the composite stream 150 of multicomponent thermoplastic polymer fibers 120 and the second material 136 into a composite nonwoven structure 154 composed of a coherent matrix of the multicomponent thermoplastic polymer fibers 120 having the second material 136 distributed therein, a collecting device is located in the path of the composite stream 150. The collecting device may be an endless belt 158 conventionally driven by rollers 160 and which is rotating as indicated by the arrow 162 in FIG. 2. Other collecting devices are well known to those of skill in the art and may be utilized in place of the endless belt 158. For example, a porous rotating drum arrangement could be utilized. The merged composite streams of multicomponent thermoplastic polymer filaments and the second material are collected as a coherent matrix on the surface of the endless belt 158 to form the composite nonwoven web 154. Vacuum boxes assist in retention of the matrix on the surface of the belt 158. The vacuum may be set at about 1 to about 4 inches of water column. Generally, in practicing the process of the present invention, as the line speed of the collecting device is increased, the frequency of the perturbation of the flow of fluid also needs to be increased.

The coform nonwoven web composite structure 154 is coherent and may be removed from the belt 158 as a self-supporting nonwoven material. Generally speaking, the composite structure has adequate strength and integrity to be used without any post-treatments such as pattern bonding, calendering and the like. However, the structure can be further stabilized by thermally bonding or compressing the composite structure. For example, a pair of pinch rollers or pattern bonding rollers, which may or may not be heated, may be used to bond portions of the material. Although such treatment may improve the integrity of the nonwoven composite structure 154, it also tends to compress and densify the structure.

If necessary or desired, the web 154 is then transported to a through air bonding (TAB) unit 170 to partially or fully activate the web 154, by bringing the polymer component A of the multicomponent filaments to a softened or liquid state where it can flow onto, or wet, the second material in the web. By the phase “partially activated” it is intended that on a portion of the A polymer component is softened or melted. By the phrase “fully activate”, it is intended to the majority or all of the A polymer component is melted or softened. Care should be taken to minimize flow of the melted sheath polymer beyond that needed to wet the absorbents. Desirably the web is subjected to between about 160° F. and about 300° F. for a period of time between about 0.5 to about 20 seconds to achieve full activation of polymer component A of the multicomponent meltblown filaments. More preferably, the time period is between about 1 to about 10 seconds and most preferably about 4-7 seconds. However, the type of polymer and the oven temperature will govern the actual time the need to melt or soften the A polymer component.

While the web 154 is partially or fully activated, it is then densified, such as by compression through a nip formed by two calender rolls 172. Densification is desirable in a preferred embodiment to between about 0.01 g/cc and 0.50 g/cc, and more desirably to between about 0.05 g/cc and 0.20 g/cc for use in some personal product applications. The calendar rolls 172 may, but need not, provide point bonding of the web and may be heated to maintain the full activation of the web during densification. Alternatively, the calendar rolls 172 may be cooled to provide a means for removing heat from the fully activated web in order to solidify the flow of polymer component A which has wetted around the second material, thereby creating hardened flow joints securing the absorbent material within the thermoplastic matrix of the web. Alternatively, the densified web 156 is fixed to form the hardened flow joints and prevent further bonding or collapse of the web by a forced air cooling unit 174 pulling ambient air through the web, or the like. The stabilized and densified web 156 can then be collected on a winding roll 176 or the like for later use, or in the alternative, the stabilized and densified web can be further processed directly from the formation process.

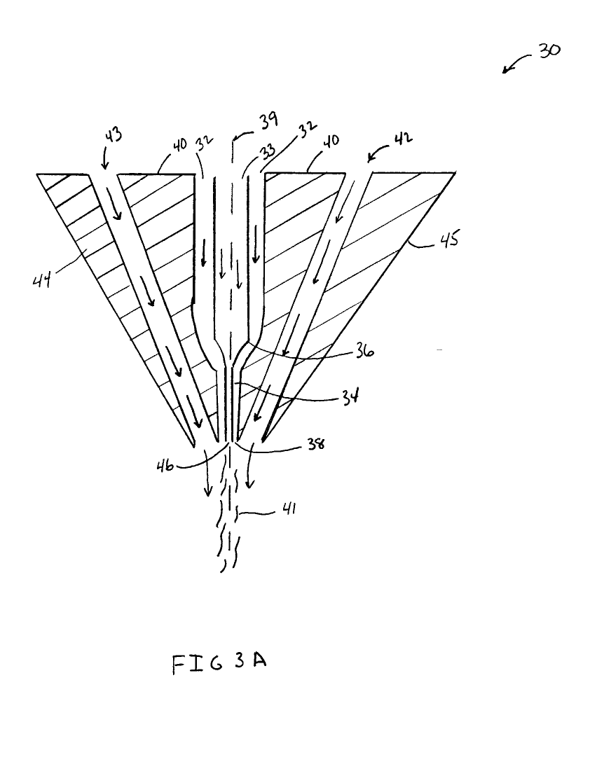

The meltblowing die of the present invention can have any configuration known to those skilled in the art. FIG. 3A shows a conventional meltblown die and FIG. 3B shows a meltblown die used with a cold air quench. These configurations for meltblown dies are well known in the art. For example U.S. Pat. No. 6,001,303 to Haynes et al, hereby incorporated by reference in its entirety, teaches a meltblown die with a cold air quench. In order to help explain the meltblown formation process herein for multicomponent filaments, the process will be briefly explained.

In FIG. 3A, a cross-section of a meltblown die 30 is shown. The polymeric components 32 and 33 are fed to a capillary 54. The polymeric components remain separated by a wall 36 until the liquefied polymeric components are at the end of the capillary, orifice 38. A die has a plurality of orifices 38. The polymeric filament components 31 and 32 are extruded through the orifices 38 in the direction of a primary axis designated by line 39. This axis bisects the die 30. A fluid stream 42 and 43 flows on each side of the orifice 38. The fluid streams 42 and 43 are perturbed as described above. The plates 44 and 45 direct the fluid stream 42 and 43 towards the orifice and the liquefied polymeric components. The fluid streams 42 and 43 attenuate and entrain the filaments formed.

In FIG. 3B, a cross-section of a cold air quench meltblown die 50 is shown. The polymeric components are has the polymeric components 52 and 53 are fed to a capillary 54. The polymeric components remain separated by a wall 56 until the liquefied polymeric components are at the end of the capillary, orifice 58. Again, the die head has a plurality of orifices 58. The polymeric components filaments 52 and 53 are extruded through the orifices 58 in the direction of a primary axis designated by line 59. This axis bisects the die 50. Fluid streams 62, 63, 72 and 73 flow on each side of the orifice 58. Fluid streams 72 and 73 are the “primary air” flows which contain cold air that attenuates and entrains the filaments with a flow in the direction of the primary axis. The fluid streams, sometimes referred to as the “secondary air”, 62 and 63 are heated only to a temperature that prevents the premature quenching of the filaments as the filaments leave the orifice 58. The plates 70 and 71 direct the fluid stream 62 and 63 towards the orifice and the liquefied polymeric components. Likewise, plates 80 and 81 direct the cold air streams 72 and 73 toward the orifice and the liquefied polymeric components. The fluid streams 72 and 73 attenuate and entrain the filaments formed. In using the cold air quench die, the primary fluid streams 72 and 73 are perturbed.

In using the cold air quench, typically the temperature of the cold air is less than the temperature of the secondary air. Generally, the cold air stream is desirably at least 300° F. below the temperature of the secondary fluid streams, however, it is not absolutely required. For more detail regarding operation of the cold air quench meltblown die, attention is directed to U.S. Pat. No. 6,001,303, to Haynes, which is hereby incorporated by reference.

The coform nonwoven web of the present invention has a more uniform structure in the z-direction wherein the second material is more homogeneously dispersed within the coform nonwoven web. It is believed that the more uniform structure of the coform material imparts better fluid handling, in particular wicking as compared to conventional coform materials.

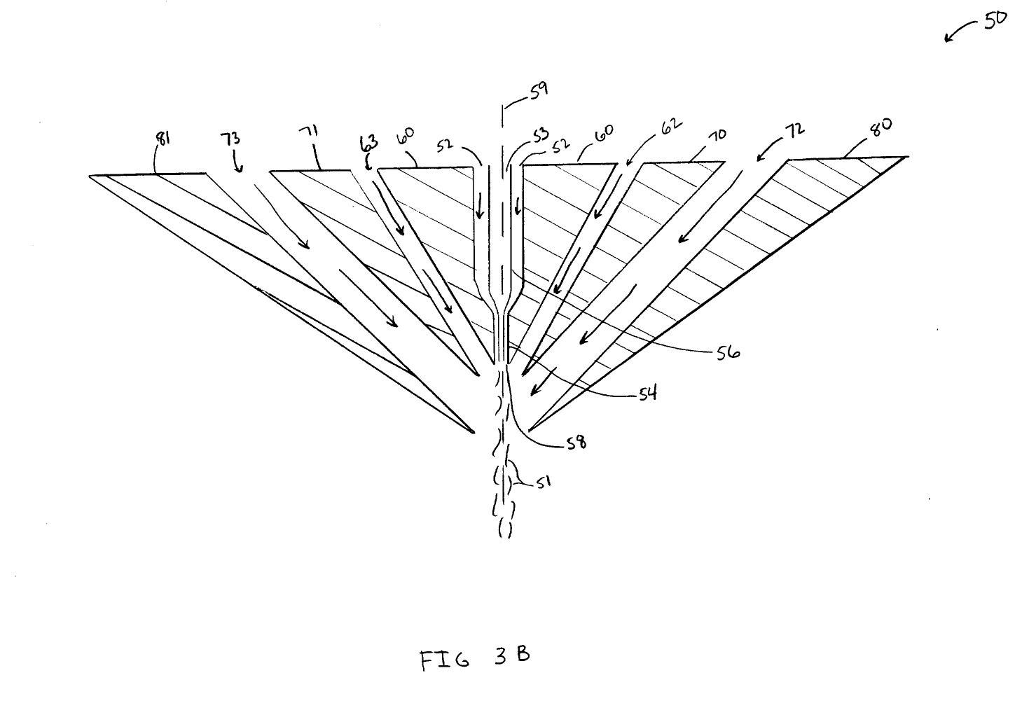

The absorbent nonwoven web of the present invention has a more vertical layering structure as compared to conventional coforming techniques. To more clearly demonstrate this, FIG. 4 diagrammatically shows the layering structure for conventional coform. As can be seen in FIG. 4, the conventional coform nonwoven web has a structure such that layers of the material overlap one another in a shingling effect. FIG. 5 diagrammatically shows the layering structure for the coform material of the present invention. As can be seen, the layering of the present invention is shorter and in a more vertical arrangement; while the layering in the conventional coform is longer and in a more horizontal direction. There is less overlapping of the layers, which may result in the improved wicking, although this has not been confirmed. This is believed to be caused by the low frequency oscillation of the filaments during formation of conventional coform and the higher level of oscillation which occurs during the formation process of the present invention.

### EXAMPLE

Four samples were run using the equipment shown in FIG. 2. A/B/A side-by-side bicomponent meltblown filaments were prepared using a polyethylene, DOW 6806, available from Dow Chemical Company, Midland Mich., as the A component and polybutylene terephthalate, Celanex 2008 available from Ticona, of Summit N.J., as the B component. The configuration of the meltblown filaments was 30/40/30 on a mass basis. The throughput of the polymeric component was 2 pounds per inch per hour. The primary airflow had a temperature of 520° F. and the auxiliary airflow was at room temperature, when used. In addition, pulp fibers was added to the meltblown fibers using a conventional picker. The formed coform composite contained 85% by weight pulp and 15% by weight A/B/A side-by-side bicomponent meltblown filaments. The resulting coformed material was heat treated in an oven at 325° F. through-air bonder and calendered with a calender roll heated to 230° F., resulting in a coform material having a density of 0.14 g/cc and a basis weight of 250 gsm. The differences between each of the coform material processes were the conditions in which the forming meltblown fibers were attenuated as they were formed at the orifices. These differences are shown in Table 1.

TABLE 1

| | Cold Air | High Speed | | |
|---|---|---|---|---|
| Sample | Quench | Rotary Valve | Valve Speed | Frequency |
| Sample 1 | No | No | 0 | 0 |
| (comparative) | | | | |
| Sample 2 | Yes | No | 0 | 0 |
| (comparative) | | | | |
| Sample 3 | Yes | Yes | 1040 rpm | 156 Hz |
| Sample 4 | Yes | Yes | 1395 rpm | 209 Hz |

The samples were tested for wicking, in-take time and rewettability in accordance with the following procedures.

Preparation of Menses Simulant:

In order to prepare the fluid, blood, in this case defibrinated swine blood, was separated by centrifugation at 3000 rpm for 30 minutes, though other methods or speeds and times may be used if effective. The plasma was separated and stored separately, the buffer coat removed and discarded and the packed red blood cells stored separately as well.

Eggs, in this case jumbo chicken eggs, were separated, the yolk and chalazae discarded and the egg white retained. The egg white was separated into thick and thin portions by straining the white through a 1000 micron nylon mesh for about 3 minutes, and the thinner portion discarded. Note that alternative mesh sizes may be used and the time or method may be varied provided the viscosity is at least that required. The thick portion of egg white which was retained on the mesh was collected and drawn into a 60 cc syringe which was then placed on a programmable syringe pump and homogenized by expelling and refilling the contents five times. In this example, the amount of homogenization was controlled by the syringe pump rate of about 100 ml/min, and the tubing inside diameter of about 0.12 inches. After homogenizing the thick egg white had a viscosity of about 20 centipoise at 150 sec⁻¹ and it was then placed in the centrifuge and spun to remove debris and air bubbles at about 3000 rpm for about 10 minutes, though any effective method to remove debris and bubbles may be used.

After centrifuging, the thick, homogenized egg white, which contains ovamucin, was added to a 300 cc Fenwal® Transfer pack using a syringe. Then 60 cc of the swine plasma was added to the transfer pack. The transfer pack was clamped, all air bubbles removed, and placed in a Stomacher lab blender where it was blended at normal (or medium) speed for about 2 minutes. The transfer pack was then removed from the blender, 60 cc of swine red blood cells were added, and the contents mixed by hand kneading for about 2 minutes or until the contents appeared homogenous. A hematocrit of the final mixture showed a red blood cell content of about 30 weight percent and generally should be at least within a range of 28-32 weight percent for artificial menses made according to this example. The amount of egg white was about 40 weight percent.

The ingredients and equipment used in the preparation of this artificial menses are readily available. Below is a listing of sources for the items used in the example, though of course other sources may be used providing they are approximately equivalent.

Blood (swine): Cocalico Biologicals, Inc., 449 Stevens Rd., Reamstown, Pa. 17567, (717) 336-1990.

Fenwal® Transfer pack container, 300 ml, with coupler, sample 4R2014: Baxter Healthcare Corporation, Fenwal Division, Deerfield, Ill. 60015.

Harvard Apparatus Programmable Syringe Pump model no. 55-4143: Harvard Apparatus, South Natick, Mass. 01760.

Stomacher 400 laboratory blender model no. BA 7021, serial no. 31968: Seward Medical, London, England, UK.

1000 micron mesh, item no. CMN-1000-B: Small Parts, Inc., PO Box 4650, Miami Lakes, Fla. 33014-0650, 1-800-220-4242.

Hemata Stat-II device to measure hemocrits, serial no. 1194Z03127: Separation Technology, Inc., 1096 Rainer Drive, Altamont Springs, Fla. 32714.

Horizontal Capillary Wicking Test Procedure:

The objective of this test it to determine the horizontal wicking capability of a material as it pulls fluid from an infinite reservoir.

Equipment needed: Horizontal wicking stand, menses simulant prepared as described below, ruler, timer.

Procedure:

1. Cut materials to 1″ (2.54 cm) width and desired length.

2. Fill reservoir in horizontal wicking apparatus with menses simulant.

3. Place one end of the material in the simulant and lay the rest of the material on the wicking apparatus.

4. Start the timer.

5. Measure the distance wicked at a given time, or the time to wick to a given distance.

Rewet Test

This test is used to determine the amount of fluid that will come back to the surface when a load is applied. The amount of fluid that comes back through the surface is called the “rewet” value. The more fluid that comes to the surface, the larger the “rewet” value. Lower rewet values are associated with a dryer material and, thus, a dryer product. In considering rewet, three properties are important: (1) intake, if the material/system does not have good intake then fluid can rewet, (2) ability of absorbent to hold fluid (the more the absorbent holds on to the fluid, the less is available for rewet), and (3) flowback, the more the cover prohibits fluid from coming back through the cover, the lower the rewet. In our case, we evaluated cover systems where the absorbent was maintained constant and, thus, we were only concerned with properties (1) and (3), intake and flowback, respectively.

A 4″×4″ piece of absorbent and cover was die cut. The absorbent used for these studies was standard and consisted of a 250 g/m² airlaid made of 90% Coosa 0054 and 10% HC T-255 binder. The total density for this system was 0.10 g/cc. The cover was placed over the absorbent and the rate block was placed on top of the two materials. In this test, 2 mL of menses simulant are insulted into the rate block apparatus and are allowed to absorb into a 4″×4″ sample of the cover material which is placed on top of a 4″×4″ absorbent piece. The fluid is allowed to interact with the system for one minute and the rate block rests on top of the materials. The material system cover and absorbent are placed onto a bag filled with fluid. A piece of blotter paper is weighed and placed on top of the material system. The bag is traversed vertically until it comes into contact with an acrylic plate above it, thus pressing the whole material system against the plate blotter paper side first. The system is pressed against the acrylic plate until a total pressure of 1 psi is applied. The pressure is held fixed for three minutes, after which the pressure is removed and the blotter paper is weighed. The blotter paper retains any fluid that was transferred to it from the cover/absorbent system. The difference in weight between the original blotter and the blotter after the experiment is known as the “rewet” value. Typically, five to ten repetitions of this test were performed, and average rewet was determined.

Triple Intake Test Procedure:

The objective of this test is to determine differences between materials and/or materials, composites or systems of material composites in the rate of intake when 3 fluid insults are applied, with time allowed for fluid to distribute in the material(s) between insults.

Equipment needed:

2 acrylic rate blocks.

P-5000 pipette with RC-5000 tips and foam pipette insert.

Small beaker

Menses simulant (made according to directions above), warmed in bath for 30 minutes or more

Small spatula (stirrer)

Bench liner

2 stopwatches

1-2 timers

Gauze squares for cleaning simulant

Procedure: Lay out sample composites according to materials testing plan.

Components are as follows:

Top: Cover

Middle: Capillarity fabric

Bottom: Retention Layer

Weigh each layer dry, record weight. Put materials back in 3-layer composite.

Weigh a dry blotter, record weight and also mark weight on blotter.

Place acrylic rate block in middle of sample composite.

Calibrate pipette:

Weigh a small empty beaker on the balance.

Set pipette to 2 mls.

Draw simulant into pipette.

Deliver simulant from pipette into beaker.

If balance indicates 2 grams of simulant was delivered, setting is correct.

If more or less than 2 grams was delivered, decrease or increase the setting and repeat adjusting pipette and weighing the amount of simulant delivered until 2 grams is delivered.

Simulant handling:

Remove simulant from the refrigerator 30 minutes to 1 hour before using and warm in water bath. Before cutting bag nozzle, massage the bag between hands for a few minutes to mix the simulant, which will have separated in the bag. Cut the bag tubing and pour simulant needed into a small beaker. Stir slowly with a small spatula to mix thoroughly. Return bag to the refrigerator if you do not anticipate using all of it. Return bag to water bath if more will be used during the day.

Test:

Step 1: Center acrylic rate block with funnel on sample. Insult sample composite with 2 mls. simulant, using stopwatch to measure the time from the start of the insult until the fluid is absorbed beneath the cover material. Leave rate block in place for 9 minutes, (use timer). For first sample, after 9 minutes remove the rate block and weigh each layer of the sample. Record the weight. (After 3 minutes timing of the first sample, start testing a second sample going through the same steps.)

Step 2: For the first sample, repeat Step 1 a second time.

Step 3: For the first sample, repeat Step 1 a third time.

Analysis: The fluid loading in each component is calculated as weight after insult subtracted from the weight before insult. The insult time is a direct measurement of time for absorption. Smaller values of intake time refer to a more absorbent sample with larger values of intake time refer to a less absorbent sample.

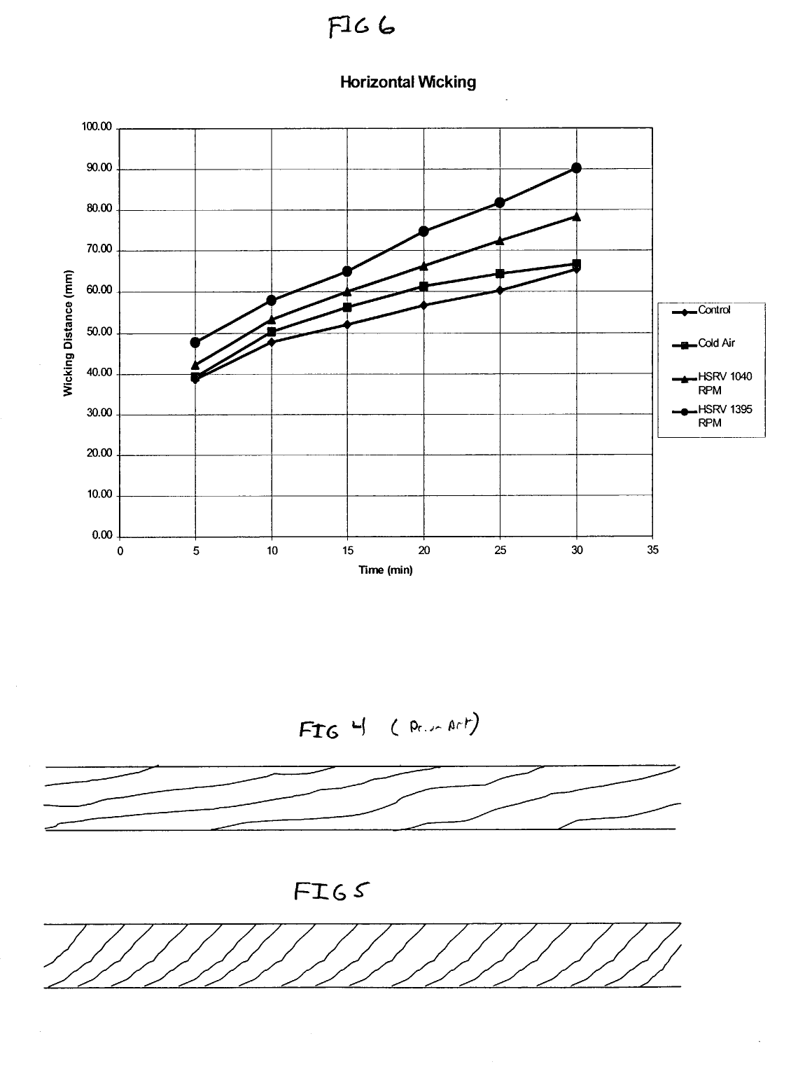

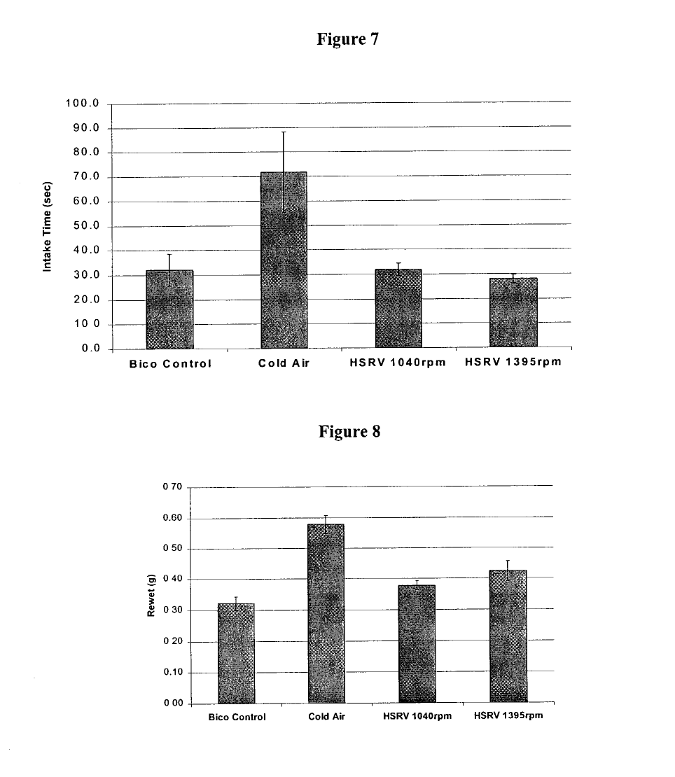

The wicking results are shown in FIG. 6, the in-take in FIG. 7 and the rewettability in FIG. 8. As can be seen in these Figures, the samples of the present invention have improved wicking as compared to the two comparative examples. In addition, perturbing the primary air negates the negative effects of using a cold-air quench and the resulting.

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

We claim:

1. A coform nonwoven web having a substantially uniform structure comprising
a plurality of substantially continuous multicomponent thermoplastic filaments; and
a second material selected from the group consisting of fibers, particles, and a mixture of fibers and particles, wherein the second material is substantially uniformly dispersed within the multicomponent thermoplastic filaments in the z-direction of the coform nonwoven web.

2. The nonwoven web of claim 1, wherein the second material comprises an absorbent material selected from the group consisting of absorbent fibers, absorbent particles and a mixture of absorbent fibers and absorbent particles.

3. The nonwoven web according to claim 2, wherein the multicomponent thermoplastic filaments comprise about 1 to about 95% by weight of the nonwoven web and the absorbent material comprise 5 to about 99% by weight of the nonwoven web.

4. The nonwoven web according to claim 3, wherein the multicomponent thermoplastic filaments comprise about 2 to about 50% by weight of the nonwoven web and the absorbent material comprise about 50 to about 98% by weight of the nonwoven web.

5. The nonwoven web according to claim 4, wherein the multicomponent thermoplastic filaments comprise about 5 to about 30% by weight of the nonwoven web and the absorbent material comprise about 70 to about 95% by weight of the nonwoven web.

6. The nonwoven web according to claim 1, wherein the multicomponent polymer comprises a polymer component selected the group consisting of polyethylene, polypropylene, polybutylene, fluropolyolefins, high pressure branched low density polyethylenes, linear low density polyethylenes having an alpha-olefin comonomer content more than about 10% by weight, copolymers of ethylene with at least one vinyl monomer, copolymers of ethylene with unsaturated aliphatic carboxylic acids or derivatives thereof, copolymers of any two alpha-olefins having 2-20 carbon atoms wherein the content of each of the two comononers exceeds 10% by weight of the copolymer, thermoplastic polyurethanes, A-B and A-B-A′ block copolymers where A and A′ are thermoplastic end blocks and B is an elastomeric block, polyamides, polyvinyl acetates, saponified polyvinyl acetates, saponified ethylene vinyl acetates, and mixtures thereof; and a second polymer component selected the group consisting of polypropylene homopolymers, polypropylene copolymers containing up to about 10% ethylene or another C₄-C₂₀ alpha-olefin comonomer, high density polyethylenes, linear low density polyethylenes in which the alpha-olefin comonomer content is less than about 10% by weight, polyamides, polyesters, polycarbonates, polytetrafluoroethylenes, and mixtures thereof.

7. The nonwoven web according to claim 2, wherein the multicomponent filaments are a bicomponent polymer.

8. The nonwoven web according to claim 2, wherein the mutlicomponent filaments have a core/sheath or a side-by-side configuration.

9. The nonwoven web according to claim 8, wherein the multicomponent filaments have an A/B/A side-by-side configuration.

10. The nonwoven web according to claim 1, having a density in the range of about 0.01 g/cc to about 0.5 g/cc.

11. The nonwoven web according to claim 1, having a density in the range of about 0.05 g/cc to about 0.2 g/cc.

12. The nonwoven web according to claim 2, comprising a horizontal wicking distance of at least 70 mm per 30 minute time period.

13. The nonwoven web according to claim 2, wherein the absorbent material comprises pulp.

14. The nonwoven web according to claim 2, wherein the absorbent material comprises a superabsorbent fiber or particle.

15. The nonwoven web according to claim 14, wherein the absorbent material further comprises pulp.

16. The nonwoven web according to claim 15, wherein the superabsorbent material is present in an amount less that about 50% by weight, based on the total weight of the absorbent material in the nonwoven web.

17. The nonwoven web according to claim 16, wherein the superabsorbent material is present in an amount between about 5 and 25% by weight, based on the total weight of the absorbent material in the nonwoven web.

18. The nonwoven web according to claim 1, further comprising an essentially vertical layering lay-down structure.

19. The nonwoven web according to claim 1, wherein the substantially continuous multicomponent filament comprises an A/B/A side by side filament in an amount between about 5 and 30% by weight of the absorbent nonwoven web, comprising, as the A polymeric component, a polymer selected from the group consisting of polyethylene, a fluoropolyolefin and polybutylene, and, as the B polymeric component, a polymer selected from the group consisting polyethylene, polyester or nylon; the absorbent material comprises pulp and is present in an amount between 70 and 95% by weight of the absorbent nonwoven web.

20. An absorbent article comprising the nonwoven web of claim 1.

21. A method of preparing the nonwoven web having a substantially uniform structure comprising a plurality of substantially continuous multicomponent thermoplastic filaments; and a second material selected from the group consisting of fibers, particles, and a mixture of fibers and particles, wherein the second material is substantially uniformly dispersed within the multicomponent thermoplastic filaments in the z-direction of the coform nonwoven web, said method comprising
a. providing a first die;
b. extruding liquefied resin components of the multicomponent thermoplastic filaments through a plurality of orifices in the first die in the direction of a first axis;
c. attenuating the liquefied resin component of the multicomponent thermoplastic filaments into a plurality of discrete filaments by subjecting the liquefied resin components to a first fluid stream directed in the direction of the first axis along both sides of the orifices, wherein the orifices are locate adjacent to the first fluid stream, the first fluid stream has a fluid pressure and the first fluid stream is perturbed by varying the fluid pressure of the first fluid stream on both sides of the orifices;
d. introducing the second material into the first fluid stream to form a mixture of multicomponent thermoplastic filaments and second material; and
e. depositing the mixture onto a forming surface to form a coform nonwoven web.

22. The method of claim 21, further comprising compacting the formed coform nonwoven web.

23. The method of claim 22, further comprising heating the formed absorbent nonwoven web before compacting the formed coform nonwoven web.

24. The method of claim 21, wherein the fluid stream along both sides of the orifices comprises at least two fluid streams in a coflowing arrangement, wherein at least one of the fluid streams on both sides of the orifice is perturbed.

25. The method of claim 24, wherein at least one stream comprises a cold air stream having a temperature below the melting point of the polymers used to prepare the multicomponent filaments and at least one stream comprises a hot air stream having a temperature sufficient to prevent premature quenching of the liquefied resin components of the forming multicomponent filaments.

26. The method of claim 25, wherein the temperature of the cold air stream is at least 300° F. below the temperature of the hot air stream.

27. The method of claim 26, wherein the cold air stream is perturbed.

28. The method of claim 26, wherein the cold air stream is perturbed by a high speed rotary valve.

29. The method of claim 21, wherein the fluid stream is perturbed by a high speed rotary valve.

30. The method of claim 21, further comprising
a′. providing a second die;
b′. extruding liquefied resin components of the multicomponent thermoplastic filaments through a plurality of orifices in the second die in the direction of a second axis;
c′. attenuating the liquefied resin component of the multicomponent thermoplastic filaments into a plurality of discrete filaments by subjecting the liquefied resin components to a second fluid stream directed in the direction of the second axis along both sides of the orifices of the second die, wherein the orifices of the second die are located adjacent to the second fluid stream, the second fluid stream has a fluid pressure and the second fluid stream is perturbed by varying the fluid pressure of the second fluid stream on both sides of the orifices of the second die;
wherein the first and second fluid streams converge to form a converged fluid stream and the second material is introduced into the converged fluid stream.

31. The method of claim 30, wherein the second material is introduced to the converged fluid stream via a chute located between the first and second dies.

32. The method of claim 30, further comprising compacting the formed coform nonwoven web.

33. The method of claim 32, further comprising heating the formed nonwoven web before compacting the formed coform nonwoven web.

34. The method of claim 30, wherein the first fluid stream along both sides of the orifice of the first die and the second fluid stream along both sides of the orifice second die comprises at least two streams in a coflowing arrangement, wherein at least one of the streams on both sides of each orifice is perturbed.

35. The method of claim 34, wherein at least one stream on each side of each orifice comprises a cold air stream having a temperature below the melting point of the polymers used to prepare the multicomponent filaments and at least one stream on each side of each orifice comprises a hot air stream having a temperature sufficient to prevent premature quenching of the liquefied resin components of the forming multicomponent filaments.

36. The method of claim 35, wherein the temperature of the cold air streams are at least 300° F. below the temperature of the hot air streams.

37. The method of claim 35, wherein the cold air streams are perturbed.

38. The method of claim 35, wherein the cold air streams are perturbed by a high speed rotary valve.

39. The method of claim 21, wherein the second material comprises an absorbent material selected from the group consisting of absorbent fibers, absorbent particles and a mixture of absorbent fibers and absorbent particles.

40. The method of claim 30, wherein the second material comprises an absorbent material selected from the group consisting of absorbent fibers, absorbent particles and a mixture of absorbent fibers and absorbent particles.
